(19) United States
(12) Patent Application Publication
(10) Pub. No.: US 2025/0146652 A1
(43) Pub. Date: May 8, 2025

(54) RAIL FOR A RAIL LIGHTING SYSTEM AND LIGHTING ARRANGEMENT

(71) Applicant: H4X e.U., Graz (AT)

(72) Inventor: Andreas HIERZER, Graz (AT)

(73) Assignee: H4X e.U., Graz (AT)

(21) Appl. No.: 18/940,698

(22) Filed: Nov. 7, 2024

(30) Foreign Application Priority Data
Nov. 8, 2023 (AT) A50899/2023

(51) Int. Cl. F21V 21/35; F21S 8/00; F21S 9/02; F21V 23/00; F21V 23/02; F21V 23/06; F21V 33/00

(52) U.S. Cl. CPC F21V 21/35; F21S 8/038; F21S 9/022; F21V 23/001; F21V 23/02; F21V 23/06; F21V 33/0056; F21V 33/0076

(57) ABSTRACT

A rail configured as a profile for a rail lighting system, having an inner region in which a conductor arrangement is provided with conductors for providing electrical current and a control signal. The inner region is configured to accommodate, at least optionally, a first adapter for contacting conductors from a first group and a second adapter for contacting conductors from at least a second group or a third group. The conductors of the first group comprise conductors for providing operating current for lighting devices and conductors for providing the control signal. The conductors of the first group are arranged between the conductors of the second and the conductors of the third group in a depth direction of the inner region, along which the first or second adapter can be inserted into the inner region starting from an outwardly open side of the inner region.

### FIELD OF THE INVENTION

The invention relates to a rail, configured as a profile, for a rail lighting system. The invention further relates to a lighting arrangement comprising a rail of this type and comprising an adapter inserted into an inner region of the rail and at least one device electrically coupled to the adapter.

### TECHNICAL BACKGROUND

Rail lighting systems, for example for lighting in buildings, are already known per se.

A lighting arrangement based on a modular rail lighting system is described, for example, in DE 10 2021 202 972 A1, a rail profile open to the visible side being described comprising a first inner region and a second inner region located above the first inner region. In DE 10 2021 202 972 A1, a conductor device for providing electrical energy and a control signal is provided in the second inner region, with a total of, for example, six or ten conductors. The second inner region is configured to accommodate an adapter unit comprising a converter. The adapter unit can be coupled to the conductor device to receive electrical energy and/or control signals. A lighting module can be inserted into the first inner region from below and is supplied by the adapter unit.

A rail for a rail lighting system is also described in DE 10 2022 204 266 A1. DE 10 2022 204 265 A1 further describes an adapter for use in a rail lighting system.

It would now be desirable, by means of a rail of a rail lighting system, not only to provide operating current and a control signal for lighting units which serve a primary lighting purpose of the rail lighting system, but also to provide a path for electrical current and/or signal(s) to implement one or more special or additional functions, while at the same time allowing a high degree of flexibility in the use of adapter units.

### SUMMARY OF THE INVENTION

Against this background, the object of the invention is to provide an option to equip a rail lighting system with a primary function on the one hand and with one or more additional function(s) on the other hand and at the same time to achieve flexible and simple usability of adapters.

According to the invention, this object is achieved by a rail having the features of claim 1 and/or by a lighting arrangement having the features of claim 17.

Accordingly, a rail for a rail lighting system is proposed, which is configured as a profile and has an inner region. In the inner region, a conductor arrangement is provided with conductors extending substantially along a longitudinal extension direction of the rail, at least for providing electrical current and a control signal. The inner region is configured to accommodate, at least optionally, a first adapter for contacting conductors from a first group of conductors and a second adapter for contacting conductors from at least a second group of conductors and/or a third group of conductors. The conductors of the first group comprise conductors for providing operating current for lighting devices and conductors for providing the control signal. The second and third groups are provided for providing at least one additional function. According to the invention, the conductors of the first group are arranged between the conductors of the second group and the conductors of the third group in a depth direction of the inner region, along which the first or second adapter can be inserted into the inner region starting from an outwardly open side of the inner region.

Furthermore, a lighting arrangement is created comprising a rail of this type according to the invention, at least one adapter inserted into an inner region of the rail, and at least one device electrically coupled to the adapter. It is provided that
the device electrically coupled to the adapter is configured as a lighting device and the adapter contacts conductors from the first group of conductors of the conductor arrangement provided in the inner region of the rail and thereby taps an operating current and a control signal for the lighting device from conductors of the first group; or that
the device electrically coupled to the adapter is provided for providing at least one additional function of the lighting arrangement and the adapter contacts at least conductors from the second group or the third group of conductors of the conductor arrangement provided in the inner region of the rail and thereby taps an operating current and/or taps or feeds in a signal for the additional function.

One idea underlying the invention is, by means of the arrangement of the first, second and third groups, to ensure that a first adapter, which provides contact with a selection of the conductors present in total-namely conductors of the first group—and can tap operating current for lighting devices and, for example, a control signal from these, is not only compatible with the rail according to the invention, but also functions with simpler rails in which the number of conductors is smaller and limited to the first group. In addition, this makes it possible to use the rail according to the invention together with first adapters which are configured for use only with an arrangement of conductors corresponding to the first group, it being possible for these adapters to be standard adapters.

Advantageously, however, not only can the first adapter be functionally contacted by the rail according to the invention, but the rail can also be used together with a second adapter capable of contacting conductors of the second and/or third group. The second adapter thus makes it possible to provide, in addition to a primary lighting function supplied via the first group, an additional or special function which can be supplied with power and/or signal(s) via the second or third group or both and/or of which the signal(s) can be forwarded via the second or third group or both.

It will be appreciated that the first and second adapters can be used in different portions of one and the same rail, possibly multiple times each. This makes a highly flexible and very functional lighting arrangement possible.

With regard to the first and second adapters, the arrangement of the first, second and third groups may also advantageously make it possible, in particular, for a first or second adapter configured for use with the rail according to the invention to have, at least in cross section, substantially the same or similar geometric external dimensions as a standard adapter for use only with conductors corresponding to those of the first group. This is advantageously achieved by arranging the first group between the second and third groups along the depth direction, in such a way that neither the second nor the third group takes up excessive additional space.

Advantageous embodiments and developments of the invention will be apparent from the dependent claims and from the description with reference to the drawings.

In an embodiment, the conductors of the first group, which are configured to provide operating current for the lighting devices, are configured to provide the operating current at mains voltage, in particular as alternating current, for example at a nominal voltage of substantially 230 V.

In a development, the first group can provide a plurality of phases of an alternating current for operating the lighting devices. This may, for example, enable the selection of a phase from these to be used by the first adapter.

In an embodiment, it is provided that the conductors of the second group comprise conductors for providing an operating current or a signal for the at least one additional function of the rail lighting system, and/or that the conductors of the third group comprise conductors for providing an operating current or a signal for the at least one additional function of the rail lighting system.

In a development, in a cross section of the rail, positions of the conductors of the conductor arrangement are arranged symmetrically about a longitudinal central plane of the inner region. This can contribute to a comparatively simple construction of the rail and in particular of the conductor arrangement, and this also facilitates the manufacture of the rail.

In an embodiment, in a cross section of the rail, the positions of the conductors of the conductor arrangement are further arranged symmetrically about a plane of symmetry extending transverse, in particular perpendicular, to the longitudinal central plane of the inner region and transverse, in particular perpendicular, to the depth direction. The space required for the conductors and in particular for the second and third groups is thus distributed more evenly in the depth direction.

In a further embodiment, the conductors of the conductor arrangement are arranged on both sides along the longitudinal sides of the inner region. In particular, the same number of conductors are arranged along each of the longitudinal sides. This makes it possible to achieve a space-saving, compact conductor arrangement, and thus a compact rail and overall a compactly constructed rail lighting system.

In a development, the conductor arrangement has ten conductors, of which five conductors are arranged along each of the longitudinal sides of the inner region, the first group comprising six of the conductors and the second and third groups each comprising two of the conductors. This makes it possible, for example, both to provide a plurality of phases as a power supply for a primary lighting function, together with an associated control signal, and to provide the additional function(s) with a sufficient additional number of conductors, which, however, is at the same time limited in such a way that only a small space requirement results, which can be divided equally between the second and third groups in a favourable manner.

In a further development, the first group comprises a neutral conductor, a first, a second and a third phase conductor, and two conductors for the control signal, in particular for a DALI signal.

In an embodiment, the first group is formed with three subgroups each comprising two of the conductors of the first group, and along the depth direction, viewed from the open side of the inner region,
the first subgroup comprises the neutral conductor and the third phase conductor,
the second subgroup comprises the two conductors for the control signal, and
the third subgroup comprises the first phase conductor and the second phase conductor.

This can further facilitate a substantially symmetrical construction of the rail, for example with a view to adapting the conductors to their intended function within the first to third subgroups, as described above.

In a development, it is provided that one of the second or third groups comprises a phase conductor and a neutral conductor of a first special alternating current circuit and the other of the second or third groups comprises a phase conductor and a neutral conductor of a second special alternating current circuit. Thus, two special or additional functions, or for example two varieties of special/additional functions of this type, can advantageously be supplied with alternating current separately.

In another embodiment, it is provided that one of the second or third groups comprises a phase conductor and a neutral conductor of a special alternating current circuit and the other of the second or third groups comprises two conductors for providing the positive and negative pole of a special direct current circuit. In this way, special or additional functions, or for example varieties thereof, can advantageously be supplied with different types of current and/or from different energy sources, such as from an alternating current network on the one hand and a battery on the other.

In another embodiment, one of the second or third groups may comprise conductors for positive and negative poles of a first special direct current circuit and the other of the second or third groups may comprise conductors for positive and negative poles of a second special direct current circuit.

In a further embodiment, it may be provided that one of the second or third groups comprises a phase conductor and a neutral conductor of a special alternating current circuit or two conductors for providing the positive and negative pole of a special direct current circuit and that the other of the second or third groups comprises two conductors for providing or forwarding a signal. In addition to an electrical energy supply for an additional function, a signal can thus be provided for this or for a second additional function or a signal assigned to an additional function can be forwarded. The signal may be, for example, another control signal or an audio signal or a data signal. For example, the audio signal may be provided for a loudspeaker or the data signal may be provided by a sensor device.

In a development, the conductors are configured to provide the positive and negative pole of the special direct current circuit or of the first and/or second special direct current circuit for providing a direct current at a direct voltage of substantially 24 V.

In a further development, the phase and neutral conductors for the special alternating current circuit or for the first and/or second special alternating current circuit are configured to provide alternating current at mains voltage, for example at a nominal voltage of substantially 230 V.

In an embodiment, the inner region is subdivided into an outwardly open first region and an inner second region, the second region being accessible through the first region, the second region being provided for receiving the adapters and the conductor arrangement being arranged within the second region, and furthermore the outwardly open first region is configured to receive one or more lighting modules, in particular flat and elongate lighting modules, in the first region, in particular to receive them substantially flush with an edge of the rail. This can help to accommodate the conductor arrangement in a well-protected manner in the inner second region, it being possible for a lighting module inserted into the first region to cover one or more adapters received in the second region. A rail lighting system constructed in this way is not only versatile, but also compact and aesthetically pleasing.

In an embodiment, side walls of the rail in the first region are each provided with an engagement geometry, in particular a groove-like or rib-like engagement geometry, for latching fastening of the lighting modules. This enables simple, quick fastening of the lighting modules, it also being possible to enable longitudinal displacement for simple position corrections.

In an embodiment of the lighting arrangement, the adapter is configured as a first adapter and has up to three contact devices on two opposite sides thereof for contacting conductors of the first group. The first adapter can thus be used when constructing the lighting arrangement to implement the primary lighting function.

In a further embodiment, it is provided that the adapter is configured as a second adapter and has at least one contact device on two opposite sides thereof for contacting a conductor of the second or third group or at least two contact devices on two opposite sides thereof for selectively contacting an associated conductor of the second or third group. A second adapter of this type may be used when implementing the additional function.

In a development, the second adapter may additionally have at least one contact device on each of the two opposite sides thereof for contacting an associated conductor of the first group. This may, for example, enable the use of a control signal provided by conductors of the first group also for use in providing the additional function.

In an embodiment of the lighting arrangement, the device electrically coupled to the adapter for providing the additional function is configured as an emergency light module or as an illuminable emergency information device or as an illuminable information device or as a loudspeaker module or as a sensor module.

In an embodiment, the adapter has a converter for converting the tapped operating current. This makes it possible to operate devices for the primary function or the additional function, in particular lighting devices, at low voltage using an operating current provided by the conductor arrangement as alternating current at mains voltage.

The above embodiments and developments can be combined with one another as desired, within reason. Other possible embodiments, developments and implementations of the invention also include combinations not explicitly mentioned of features of the invention which are described above or in the following in relation to the example embodiments. In particular, a person skilled in the art will also add individual aspects as improvements or additions to each basic form of the present invention.

### BRIEF DESCRIPTION OF THE DRAWINGS

The invention is explained in greater detail below with reference to the embodiments shown in the drawings, in which:

FIG. 1 is a cross-sectional view of a rail according to an embodiment of the invention;

FIG. 2 is a cross-sectional view of the rail of FIG. 1 with an inserted first adapter of a first type and a direct lighting module;

FIG. 3 is a cross-sectional view of the rail of FIG. 1 with an inserted first adapter of a second type and an indirect lighting module;

FIG. 4 is a cross-sectional view of the rail of FIG. 1 with an inserted first adapter of a third type and an adjustable radiator;

FIG. 5 is an example perspective open partial view of the first adapter of the third type from FIG. 4;

FIG. 6 is a cross-sectional view of the rail of FIG. 1 with an inserted second adapter of a first type and an illuminated, panel-like emergency light module;

FIG. 7 is a cross-sectional view of the rail of FIG. 1 with an inserted second adapter of a second type and an illuminated panel-like emergency light module;

FIG. 8 is a cross-sectional view of the rail of FIG. 1 with an inserted second adapter of a third type and an illuminated panel-like emergency light module;

FIG. 9 is a cross-sectional view of the rail of FIG. 1 with an inserted second adapter of a fourth type and an illuminated panel-like emergency light module;

FIG. 10 is a perspective open partial view of a second adapter of a fifth type; and

FIG. 11 shows a lighting arrangement according to an embodiment, with the rail of FIG. 1, the first adapter and lighting module of FIG. 2, and the second adapter and emergency light module of FIG. 6.

The accompanying drawings are intended to convey further understanding of embodiments of the invention. They illustrate embodiments and, in conjunction with the description, serve to explain principles and concepts of the invention. Other embodiments and many of the stated advantages will be apparent from referring to the drawings. The elements of the drawings are not necessarily shown to scale with one another.

In the drawings, like, functionally equivalent and equivalently acting elements, features and components are provided with like reference numbers, unless stated otherwise.

### DESCRIPTION OF EMBODIMENTS

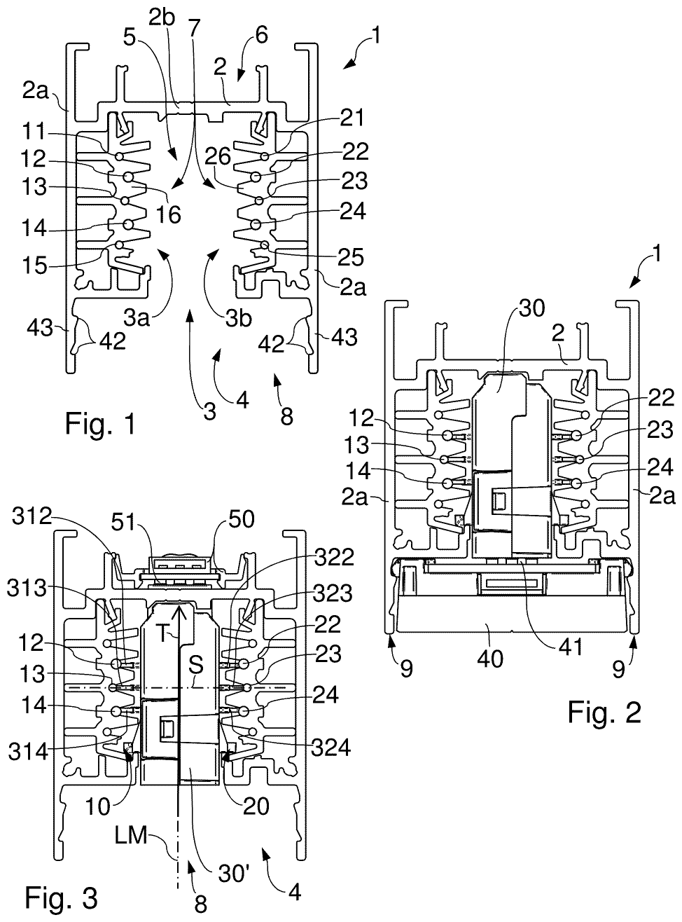

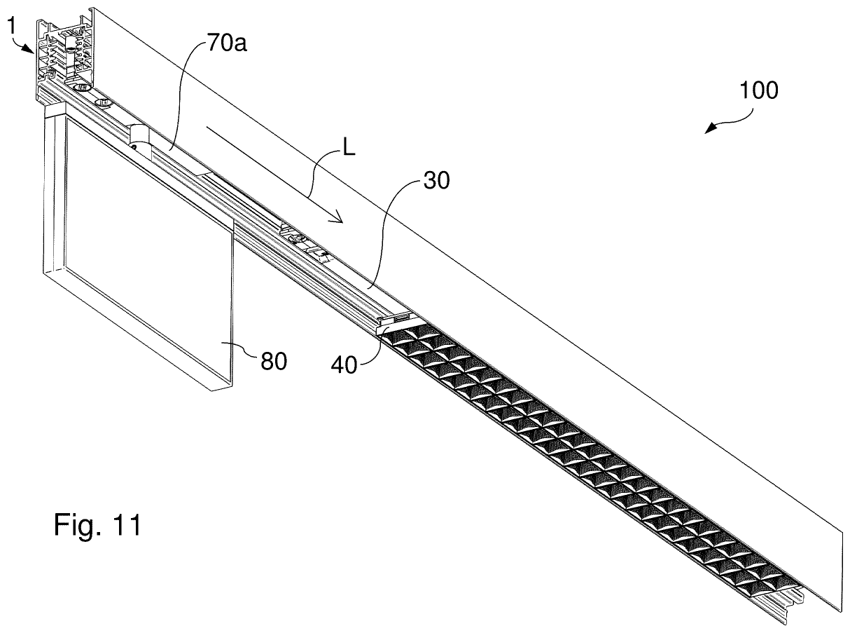

FIGS. 1-4, 6-9 and 11 show a rail 1 configured as a profile according to an embodiment, which is part of a rail lighting system. In a longitudinal extension direction L (see FIG. 11), the rail 1 has a substantially constant cross section. The rail 1 comprises a profile base body 2 formed from a metal material, in particular an aluminium material, with side walls 2a connected by a web 2b.

An inner region 3 of the rail 1 is subdivided into a first region 4 open to the outside and an inner second region 5. The second region 5 is accessible through the first region 4. Within the second region 5, a conductor arrangement 7 is provided which has a first part 10 and a second part 20 arranged on both sides along longitudinal sides 3a, 3b of the inner region 3. Each of the parts 10 and 20 has a holding body 16 or 26 formed from an electrically insulating material, in particular a plastics material, and electrical conductors 11, 12, 13, 14, 15 or 21, 22, 23, 24, 25 held by the holding body 16, 26. The conductors 11-15, 21-25 may be formed from copper, for example. In the second region 5, first adapters 30, 30′, 30″ and second adapters 70a-d, 70 can be substantially completely accommodated.

The conductors 11-15, 21-25 extend in the inner second region 5 parallel to the longitudinal extension direction L of the rail 1. In the embodiments shown in the drawings, each of the parts 10, 20 of the conductor arrangement 7 comprises five conductors 11-15 and 21-25 respectively, and thus the conductor arrangement 7 has a total of ten conductors 11-15, 21-25. The five conductors 11-15 are arranged along the longitudinal side 3a of the inner region 3, and the five conductors 21-25 along the opposite longitudinal side 3b of the inner region 3.

FIG. 3, 4 show a depth direction T of the inner region 3, along which each of the adapters 30, 30′, 30″, 70a-d, 70 can be inserted into the inner region 3 starting from an outwardly open side 8 of the inner region. For this purpose, the adapter 30, 30′, 30″, 70a, 70b, 70c, 70d or 70 is introduced through the first region 4 in the depth direction T and transverse to the longitudinal extension direction L into the second region 5.

In the cross section of the rail 1, positions of the conductors 11-15 are arranged symmetrically with respect to positions of the conductors 21-25 about a longitudinal central plane LM of the inner region 3. Furthermore, the positions of the conductors 11, 12, 21, 22 in the cross section of the rail 1 are arranged symmetrically with respect to the positions of the conductors 15, 14, 25, 24 about a plane of symmetry S extending normal to the longitudinal central plane LM of the inner region 3 and normal to the depth direction T and extending through the two conductors 13, 23; see for example FIGS. 1 and 3.

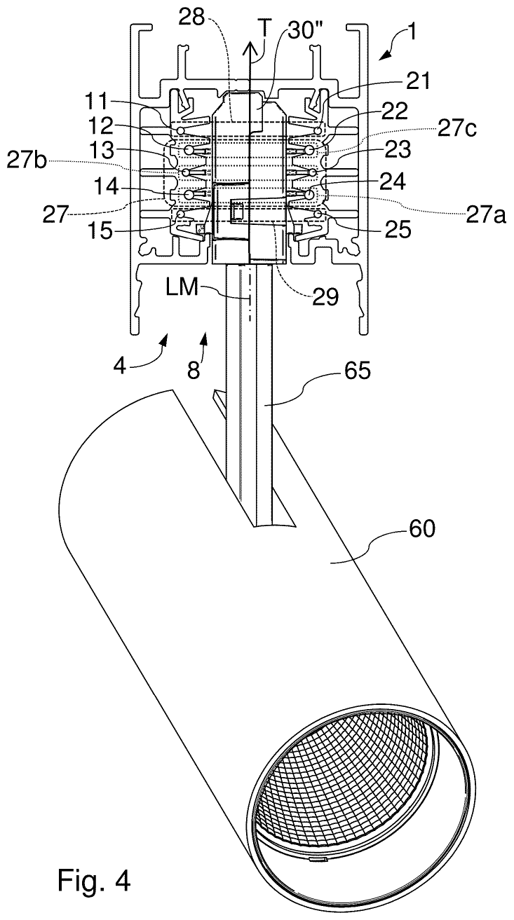

The entirety of the conductors 11-15, 21-25 is divided into a first group 27, a second group 28 and a third group 29; see FIG. 4. The first group 27 is formed with the six conductors 12, 13, 14 and 22, 23, 24. The second group 28 is formed with the two conductors 11 and 21, and the third group 29 is formed with the two conductors 15 and 25.

Viewed in the depth direction T (FIG. 4), the conductors 12-14, 22-24 of the first group 27 are arranged between the conductors 11, 21 of the second group 28 and the conductors 15, 25 of the third group 29. In an assembled state of the rail 1, the depth direction T can in particular be aligned substantially vertically, and in this assembled state the second group 28 is arranged above the first group 27 and the third group 29 is arranged below the first group 27.

The conductors 12, 14, 22, 24 are configured to provide operating current for lighting devices 40, 50, 60, explained in greater detail below, and the conductors 13, 23 are configured to provide a control signal. The control signal can be interpreted by the adapter 30, 30′, 30″ or by the lighting device 40, 50, 60.

The first group 27 is subdivided into three subgroups 27a, 27b and 27c, each of which is formed with two of the electrical conductors 12-14, 22-24 of the first group 27. Starting from the open side 8, along the depth direction T, the third group 29 is followed by the first subgroup 27a, then the second or central subgroup 27b, then the third subgroup 27c, and then the second group 28.

The conductors 12, 14, 22, 24 of the first and third subgroups 27a, 27c are configured to provide the operating current for the lighting devices 40, 50, 60 at mains voltage, and in particular as alternating current having a nominal voltage of 230 V and a frequency of 50 Hz. In the rail 1 shown in the drawings, a first phase L1 is applied to the conductor 12, a second phase L2 to the conductor 22, a third phase L3 to the conductor 24 and zero to the conductor 14. The first group 27 thus provides the phases L1, L2, L3 of the mains alternating current for operating the lighting devices 40, 50, 60. An earth contact can be provided by the profile base body 2.

The first subgroup 27a is formed with the conductors 14 and 24, the conductor 14 serving as the neutral conductor and the conductor 24 as the third phase conductor. The third subgroup 27c is formed with the conductors 12 and 22, the conductor 12 serving as the first phase conductor and the conductor 22 as the second phase conductor.

The second subgroup 27b is formed with the two conductors 13, 23, by means of which the control signal, which can be used in particular to control the lighting devices 40, 50 and/or 60, is provided. The control signal is in particular a DALI signal. Instead, in variants it may be provided that the conductors 13, 23 provide a control signal based on another suitable protocol.

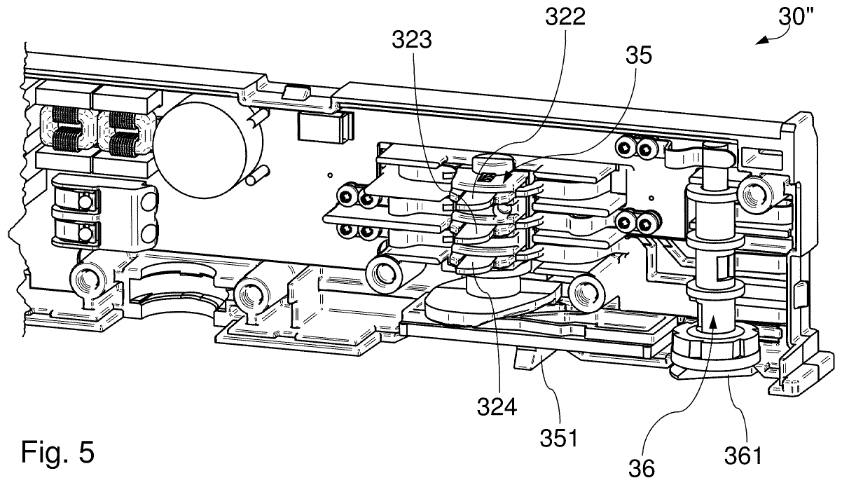

In the rail lighting system, the first adapter 30, 30′, 30″ can be configured in particular according to a first type, designated 30, according to a second type, designated 30′, or according to a third type, designated 30″. The first adapters 30, 30′, 30″ inserted into the inner second region 5 of the inner region 3 are respectively configured to contact the conductors 12-14 and 22-24. When inserted and electrically coupled to the rail 1, the adapter 30, 30′, 30″ preferably contacts all of the conductors 12-14, 22-24. For this purpose, the adapter 30, 30′, 30″ is equipped with contact devices 312, 313, 314 and 322, 323, 324, which can be pivoted out from the side of a housing thereof and which are configured, for example, as pivotable contact tongues; see FIGS. 3 and 5. As regards contacting the conductors 12-14, 22-24, the first adapters 30, 30′, 30″ are configured in the same way.

The first region 4, which is open to the outside, is configured to accommodate one or more flat, elongate, linear lighting modules 40, for example to form a light strip, in such a way that the lighting module 40 (also referred to as a linear inset), which is intended in particular for direct lighting, is substantially flush with the visible-side edges 9 of the rail 1; see FIG. 2.

The first adapter 30 of the first type makes it possible to supply and control the lighting module 40. In the region of a side facing the first region 4 after the adapter 30 has been inserted, the adapter 30 has contact elements 41 which can come into contact with corresponding contact elements of the lighting module 40 in order to supply it with electrical power and to control it.

The side walls 2a of the rail 1 are each provided, in portions 43 on the inside in the first region 4, with an engagement geometry 42, which in the embodiment in the drawings is partly groove-like and partly rib-like and enables latching fastening of the lighting modules 40.

FIG. 3 shows the adapter 30′ of the second type inserted into the inner second region 5, which differs from the first adapter 30 in particular in that the contact elements 41 are omitted in the adapter 30′. Instead, the adapter 30′ has a contact portion (not shown in detail in FIG. 3) on its upper side, which protrudes through an opening provided for this purpose in the web 2b. The contact portion carries contact elements 51, which contact corresponding contact elements of an indirect lighting module 50 to supply it with electrical energy and to enable it to be controlled. The indirect lighting module 50 is accommodated in a third region 6, which is arranged on a side of the web 2b facing away from the inner, second region 5 and is open to the outside, upwards in FIG. 3. The indirect lighting module 50 is snapped into the region 6.

FIG. 4 shows the adapter 30″ of the third type inserted into the inner, second region 5, which enables the supply and control of a lighting device 60 configured as an adjustable spotlight. The lighting device 60 is pivotably connected to a rod-like connector 65 and coupled to the adapter 30″ via the connector 65, the connector 65 being rotatably mounted on the adapter 30″.

The first adapter 30″ is shown in portions in FIG. 5 with the housing open by way of example to illustrate the contacting of the conductors 12-14, 22-24 and a phase selection, the contacting of the conductors 12-14, 22-24 and the phase selection being provided in the same way for the first adapters 30, 30′.

The adapter 30, 30′, 30″ has a rotary component 35, which is in particular formed with a cylindrical shape in portions and on which the contact devices 312, 313, 314 and 322, 323, 324 configured as contact tongues are arranged. The rotary component 35 can be rotated about an axis extending parallel to the depth direction T when the adapter 30, 30′, 30″ is inserted into the second region 5. In this way, the contact devices 312-314, 322-324 can be swung out of the housing of the adapter 30, 30′, 30″ or into the housing of the adapter 30, 30′, 30″ through associated openings. When swung out (see FIG. 1-4), the contact devices 312, 313, 314 contact the conductors 12, 13 and 14 respectively, and the contact devices 322, 323, 324 contact the conductors 22, 23 and 24 respectively. Three contact devices 312-314 and 322-324 are provided on two opposite longitudinal sides of the adapter 30, 30′, 30″ and can be swung out for contacting.

The rotary component 35 is coupled to a sliding control element 351 via a mechanism in such a way that, by moving the sliding control element 351, the rotary component 35 can be rotated between a contact position with the contact devices 312-314, 322-324 pivoted out and a non-contact position with the contact devices 312-314, 322-324 pivoted in. The sliding control element 351 is accessible to an operator through the first region 4 when the adapter 30, 30′, 30″ is inserted into the second region 5. The adapter 30, 30′, 30″ can be additionally fixed via a pivotable portion of the rotary component 35 and/or with the aid of latch elements.

The adapter 30, 30′, 30″ further has a phase selection device 36 configured with a rotary selector switch which can be rotated about an axis, parallel to the depth direction T in the inserted state, by means of a rotary control element 361, which is still accessible to the operator when the adapter 30, 30′, 30″ is inserted. By mechanically rotating the rotary selector switch, the phase L1, L2 or L3 to be used to supply the lighting device 40, 50 or 60 can be selected as desired or required and can be electrically connected, for example, to a converter of the first adapter 30, 30′, 30″.

The converter of the first adapter 30, 30′, 30″ is not shown in greater detail in the drawings, and converts the alternating current absorbed by the conductor device 7 according to the selected phase L1, L2 or L3 for supplying the lighting device 40, 50, 60 with low voltage.

The rail 1 is further configured to accommodate a second adapter 70a-d, 70 for contacting the conductors 11, 21 of the second group 28 and/or the conductors 15, 25 of the third group 29.

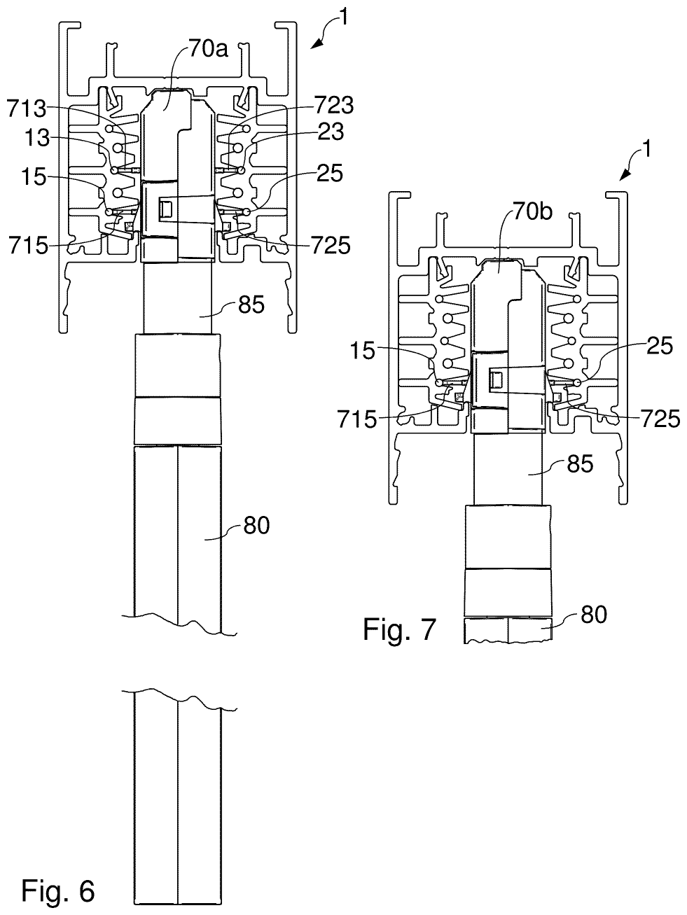

FIG. 6-10 show second adapters 70a-70d and 70 according to a first to fifth type. The second adapter 70a-d, 70 serves in each case to implement a special or additional function of a lighting arrangement constructed on the basis of the modular rail lighting system. For this purpose, an electrically operated device 80 is electrically coupled to the adapter 70a-d, 70. The device 80 can be configured as an emergency light module or as a luminous emergency information device or as a luminous indication device. Alternatively, the device 80 may be configured as a loudspeaker module or as a sensor module. In FIG. 6-11, the device 80 is configured as an emergency light module, for example an electrically illuminated emergency information board, which highlights for example an escape route, emergency exit or the like and can also provide emergency lighting, and is coupled to the second adapter 70a-d, 70 via a connector 85.

An external geometry of the second adapters 70a-d, 70 substantially corresponds to that of the first adapters 30, 30′, 30″. However, the adapters 70a-d, 70 differ from the adapters 30, 30′, 30″ in the contacting of the conductor device 7.

The second adapter 70a according to the first type in FIG. 6 has, on both longitudinal sides thereof, pivotable contact devices 715 and 725 for contacting the conductors 15 and 25 of the third group 29 and pivotable contact devices 713 and 723 for contacting the conductors 13 and 23 of the first group 27.

In the configuration of the rail 1 illustrated in the drawings, the conductor 21 is provided as a phase conductor for providing a phase of a first special alternating current circuit and the conductor 11 as a neutral conductor of the first special alternating current circuit.

Furthermore, the conductor 25 is provided as a phase conductor of a second special alternating current circuit and the conductor 15 as a neutral conductor of the second special alternating current circuit. The first and second special alternating current circuits can each provide alternating current as operating current for the additional function(s), for example at a nominal voltage of 230 volts and a frequency of 50 Hz. For example, the second and third group 28, 29 can be supplied from one or more different energy sources from the first group 27, which serves the primary lighting function.

By means of the second adapter 70a of the first type, the device 80 which provides the additional function, such as the emergency light and/or an illuminated sign, is supplied with electrical energy via the second special alternating current circuit from the third group 29. Control may take place for example via the existing DALI conductors 13, 23.

In the second adapter 70b according to the second type in FIG. 7, the contact devices 713, 723 are omitted, and so there is no control via the DALI conductors 13, 23. This makes a simple adapter 70b possible, for example if the device 80 is to be operated without the need for a controller.

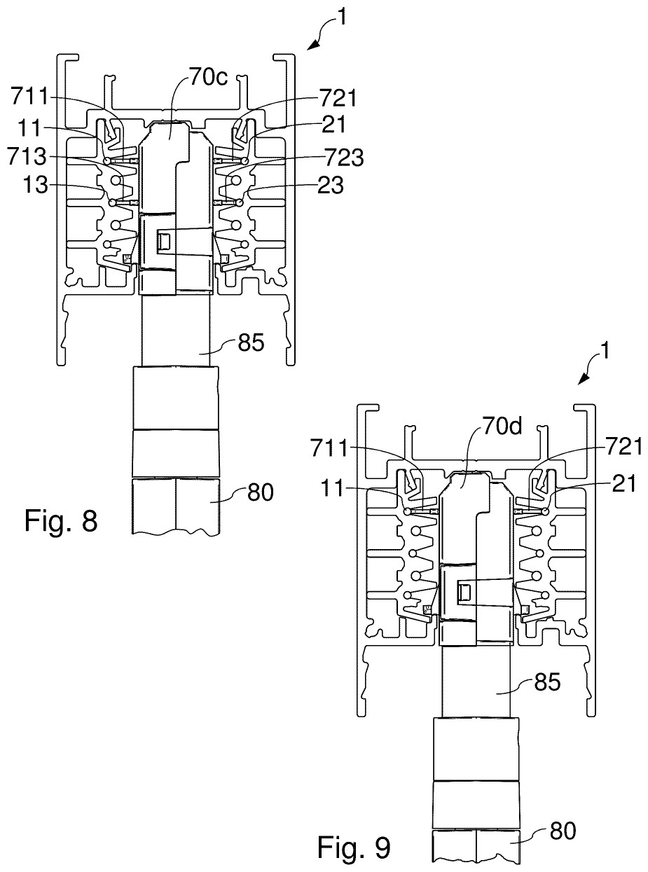

The second adapter 70c according to the third type in FIG. 8 has, on both longitudinal sides thereof, pivotable contact devices 711 and 721 for contacting the conductors 11 and 21 of the second group 28 as well as pivotable contact devices 713 and 723 for contacting the conductors 13 and 23 of the first group 27.

By means of the second adapter 70c of the third type, the device 80 which provides the additional function, such as the emergency light and/or an illuminated sign, is supplied with electrical energy via the first special alternating current circuit from the second group 28. Control can be carried out, for example, via the existing DALI conductors 13, 23.

In the second adapter 70d according to the fourth type in FIG. 9, starting from the second adapter 70c of the third type, the contact devices 713, 723 are again omitted, and so there is no control via the DALI conductors 13, 23. This in turn makes a simplified adapter 70d possible.

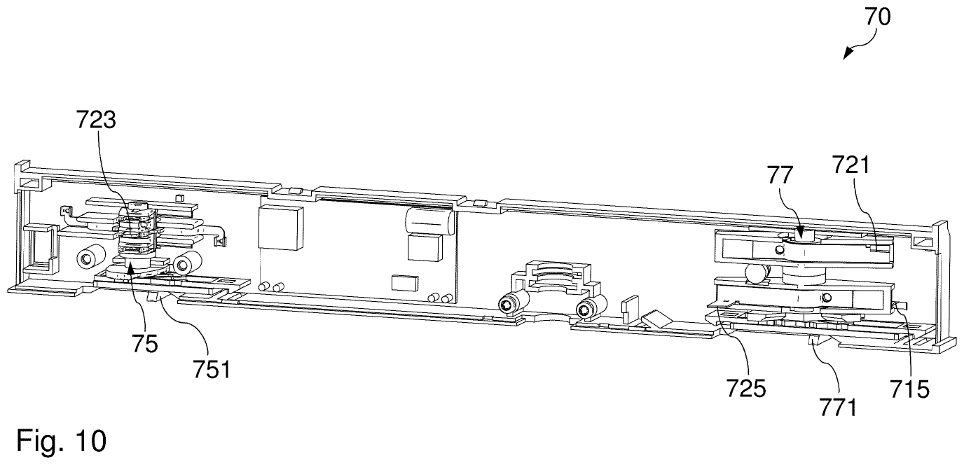

FIG. 10 illustrates the second adapter 70 of the fifth type in perspective with the housing open. The adapter 70 of the fifth type combines all of the contacting options described in FIG. 6-9 for the first to fourth types of the second adapter, which can therefore be selected as required for the second adapter 70 of the fifth type. The second adapter 70 therefore offers even greater flexibility in use.

The second adapter 70 of the fifth type has a rotary component 75 which is configured substantially analogously to the rotary component 35 of the adapter 30, 30′, 30″ and can be pivoted by an operator via a sliding control element 751 when the adapter 70 is inserted into the second region 5. Unlike the first adapter 30, 30′, 30″, the rotary component 75 only carries two contact devices 713, 723 arranged in a central position and configured as contact tongues, analogous to the contact devices 313, 323, so as selectively to contact or not to contact the two conductors 13, 23, depending on the position of the sliding control element 751 and the resulting rotary position of the rotary component 75.

In addition, the adapter 70 of the fifth type has a pivoting component 77 which can be pivoted like a rocker about an axis extending parallel to the depth direction T when the adapter 70 is inserted. The tongue-shaped contact devices 711, 721, 715, 725 are arranged on the pivoting component 77 in such a way that the contact devices 711, 715 on one longitudinal side and the contact devices 721, 725 on the other longitudinal side of the adapter 70 can be pivoted out through associated housing openings. The pivoting component 77 comprising the contact devices 711, 715, 721, 725 is set up in such a way that either the conductors 11, 21 can be contacted by the contact devices 711, 721 or else the conductors 15, 25 can be contacted by the contact devices 715, 725, but not all conductors 11, 15, 21, 25 at the same time. The pivoting component 77 thus also makes it possible to select the special or emergency power circuit. For insertion into or removal from the rail 1, the pivoting component 77 is brought into a central position. The pivoting of the pivoting component 77 is made possible by means of a sliding control element 771, which is accessible to the operator when the adapter 70 is inserted and is coupled to the pivoting component 77 via a mechanism not shown in detail.

Starting from the second adapter 70 according to the fifth type, a second adapter, which has for example the contacting function of the second adapters 70b, 70d of the second and fourth type and thus selectively and alternatively contacts the second or third group 28 or 29, can be formed by omitting the rotary component 75. Furthermore, in further variants, by additionally omitting the contact devices 711, 721 or 715, 725, the adapter 70b may be formed only for contacting the third group 29 or the adapter 70d may be formed only for contacting the second group 28. If, however, contact devices 711, 721 or else 715, 725 are omitted from the pivoting component 77 and the rotary component 75 is also provided, an adapter 70a for contacting the third group 29 and optionally also the DALI conductors 13, 23 or an adapter 70c for contacting the second group 29 and optionally also the DALI conductors 13, 23 may be formed. The contacting situations shown in FIGS. 6-9 may also all be achieved selectively using the second adapter 70 of the fifth type.

The second adapter 70a-d, 70 may include a converter to operate the device 80 at low voltage.

In variants of the embodiment, the second group 28 and/or the third group 29 may be assigned and used differently from what is described above. For example, it may be provided that only the conductors 11, 21 provide zero or phase of a special alternating current circuit of the second group 28 or else only the conductors 15, 25 of the third group 29 provide zero or phase of a special alternating current circuit, the other two conductors 15, 25 or 11, 21 of the other group 29 or 28 providing the positive and negative pole of a direct current circuit, for example at a direct voltage of 24 volts. It is conceivable, for example, to supply the direct current circuit via a battery in such a way that the special or additional function, such as the illumination of the information board 80 with emergency light, is retained in the event of a power failure. It will be appreciated that in other variants both of the second and third groups 28, 29 may each provide poles of an associated one of two direct current circuits.

In addition, the conductors 11, 21 of the second group 28 and/or the conductors 15, 25 of the third group 29 can be used to provide a signal for an additional function, instead of for power supply using alternating or direct current. The device 80 may for example be configured as a sensor module or as a loudspeaker module instead of as an illuminated panel or emergency light. In these variants, the conductors 11, 21 and/or 15, 25 may transmit a signal from the sensor module via the second adapter 70a-d, 70 or instead supply an audio signal to the loudspeaker module via the second adapter.

It will be appreciated that one of the groups 28, 29 may be used for a signal of this type and the other of the groups 28, 29 may be used for an emergency or special operating current, in the form of alternating current or of direct current.

A lighting arrangement 100 comprising a rail 1, adapters 30 and 70a inserted into the inner region 3, a lighting module 40 electrically coupled to the first adapter 30 for a primary lighting function and a device 80 electrically coupled to the second adapter 70a, which is configured as a luminous emergency information board, is shown by way of example in FIG. 11. The lighting device 40 is supplied and controlled via the adapter 30 on the basis of the alternating current and signal provided by the first group 27. The device 80 is supplied, for example, via the second adapter 70a on the basis of the separate circuit provided by the third group 29 (see also FIG. 6), the adapter 70a additionally making it possible for the device 80 to be controlled on the basis of the DALI signal applied to the conductors 13, 23 of the first group 27. The device 80 thus offers an additional function which is supplied with electrical energy separately.

The adapters 30, 30′, 30″ with associated lighting units 40, 50, 60 and the adapters 70a-d, 70 with associated device 80 of different types can be combined in a variety of ways along the rail 1 and may be present more than once.

In particular, it is apparent from FIGS. 1-4 and 6-9 that the arrangement of the first, second and third groups 27, 28, 29, the first group 27 with six conductors being located between the second and third groups 28, 29 each with two conductors, makes it possible for the rail 1 to be constructed compactly. At the same time, it becomes possible to use first adapters 30, 30′, 30″ of different types to implement a lighting function as the primary function of the rail lighting system, by means of for example the lighting devices 40, 50, 60. Furthermore, it becomes possible to use second adapters 70, 70a-d of different types in the same rail 1, which access the conductors 11, 21 and 15, 25 of the second and/or third group 28, 29 respectively, and in some variants the conductors 13 and 23. At the same time, for example, a first adapter 30, 30′, 30″ may also be used without any problems with a simpler rail that only has conductors corresponding to those of the first group 27, and standard adapters configured for simpler rails of just this type may equally be used in the rail 1, as explained above with reference to FIGS. 1-11. Consequently, extraordinarily high flexibility and versatility of the rail lighting system are achieved.

Although the present invention has been fully described above with reference to preferred embodiments, it is not limited thereto but can be modified in many ways.

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever.

In the foregoing and in the examples, all temperatures are set forth uncorrected in degrees Celsius and, all parts and percentages are by weight, unless otherwise indicated.

The entire disclosures of all applications, patents and publications, cited herein and of corresponding Austrian application No. A50899/2023, filed Nov. 8, 2023, are incorporated by reference herein.

The preceding examples can be repeated with similar success by substituting the generically or specifically described reactants and/or operating conditions of this invention for those used in the preceding examples.

From the foregoing description, one skilled in the art can easily ascertain the essential characteristics of this invention and, without departing from the spirit and scope thereof, can make various changes and modifications of the invention to adapt it to various usages and conditions.

### REFERENCE SYMBOL LIST

1 Rail
2 Profile base bodies
2a Side wall
2b Web
3 Inner region
3a, 3b Longitudinal side (inner region)
4 First region
5 Second region
6 Third region
7 Conductor arrangement
8 Side open to the outside
9 Edge
10 First part (conductor arrangement)
20 Second part (conductor arrangement)
11, 12, 13, 14, 15 Conductor
16 Holding bodies
21, 22, 23, 24, 25 Conductor
26 Holding bodies
27 First group
27a First subgroup (first group)
27b Second subgroup (first group)
27 Third subgroup (first group)
28 Second group
29 Third group
30, 30′, 30″ First adapter
35 Rotary components
36 Sliding control element
36 Phase selection device
361 Rotary control element
312-314, 322-324 Contact device
40 Light modules
41 Contact element
42 Engagement geometry
43 Portion (side wall)
50 Indirect lighting modules
51 Contact element
60 Spotlights
65 Connector
70a, 70b Second adapter
70c, 70d Second adapter
70 Second adapter
75 Rotary components
751 Sliding control element
77 Pivoting component
771 Sliding control element
711, 721 Contact device
713, 723 Contact device
715,725 Contact device
80 Device
85 Connector
100 Lighting arrangement
L Longitudinal extension direction (rail)
LM Longitudinal central plane (inner region)
S Plane of symmetry
T Depth direction (inner region)

1. Rail (1) for a rail lighting system,
which is configured as a profile and has an inner region (3),
wherein, in the inner region (3), a conductor arrangement (7) is provided with conductors (11-15, 21-25) extending substantially along a longitudinal extension direction (L) of the rail (1), at least for providing electrical current and a control signal,
wherein the inner region (3) is configured to accommodate, at least optionally, a first adapter (30, 30′, 30″) for contacting conductors (12-14, 22-24) from a first group (27) of conductors (11-15, 21-25) and a second adapter (70a-d, 70) for contacting conductors (11, 21, 15, 25) from at least a second group (28) of conductors (11-15, 21-25) and/or a third group (29) of conductors (11-15, 21-25),
wherein the conductors (12-14, 22-24) of the first group (27) comprise conductors (12, 14, 22, 24) for providing operating current for lighting devices (40, 50, 60) and conductors (13, 23) for providing the control signal,
wherein the second and third groups (28, 29) are intended to provide at least one additional function, and
wherein the conductors (12-14, 22-24) of the first group (27) are arranged between the conductors (11, 21) of the second group (28) and the conductors (15, 25) of the third group (29) in a depth direction (T) of the inner region (3), along which the first or second adapter (30, 30′, 30″, 70a-d, 70) can be inserted into the inner region (3) starting from an outwardly open side (8) of the inner region.

2. Rail according to claim 1, characterised
in that the conductors (12, 14, 22, 24) of the first group (27), which are configured to provide operating current for the lighting devices (40, 50, 60), are configured to provide the operating current at mains voltage, in particular as alternating current, for example at a nominal voltage of substantially 230 V.

3. Rail according to claim 1, characterised in that the first group (27) can provide a plurality of phases of an alternating current for operating the lighting devices (40, 50, 60).

4. Rail according to one of the preceding claims, claim 1, characterised
in that the conductors (11, 21) of the second group (28) comprise conductors for providing an operating current or a signal for the at least one additional function of the rail lighting system, and/or in that the conductors (15, 25) of the third group (29) comprise conductors for providing an operating current or a signal for the at least one additional function of the rail lighting system.

5. Rail according to claim 1, characterised
in that, in a cross section of the rail (1), positions of the conductors (11-15, 21-25) of the conductor arrangement (7) are arranged symmetrically about a longitudinal central plane (LM) of the inner region (3).

6. Rail according to claim 5, characterised
in that, in a cross section of the rail (1), the positions of the conductors (11-15, 21-25) of the conductor arrangement (7) are further arranged symmetrically about a plane of symmetry(S) extending transverse, in particular perpendicular, to the longitudinal central plane (LM) of the inner region (3) and transverse, in particular perpendicular, to the depth direction (T).

7. Rail according to claim 1, characterised
in that the conductors (11-15, 21-25) of the conductor arrangement (7) are arranged on both sides along longitudinal sides (3a, 3b) of the inner region (3) and in particular in that the same number of conductors (11-15, 21-25) are arranged along each of the longitudinal sides (3a, 3b).

8. Rail according to claim 7, characterised
in that the conductor arrangement (7) has ten conductors (11-15, 21-25), of which five conductors are arranged along each of the longitudinal sides (3a, 3b) of the inner region (3), the first group (27) comprising six of the conductors (11-15, 21-25) and the second and third groups (28, 29) each comprising two of the conductors (11-15, 21-25).

9. Rail according to one of the preceding claims, claim 1, characterised
in that the first group (27) comprises a neutral conductor (14), a first (12), a second (22) and a third phase conductor (24), and two conductors (13, 23) for the control signal, in particular a DALI signal.

10. Rail according to claim 9, characterised
in that the first group (27) is formed with three subgroups (27a, 27b, 27c) each comprising two of the conductors (12-14, 22-24) of the first group (27), and in that along the depth direction (T), viewed from the open side (8) of the inner region (3),
the first subgroup (27a) comprises the neutral conductor (14) and the third phase conductor (24),
the second subgroup (27b) comprises the two conductors (13, 23) for the control signal, and
the third subgroup (27c) comprises the first phase conductor (12) and the second phase conductor (22).

11. Rail according to claim 1, characterised in that one of the second or third groups (28, 29) comprises a phase conductor (21) and a neutral conductor (11) of a first special alternating current circuit and the other of the second or third groups (28, 29) comprises a phase conductor (25) and a neutral conductor (15) of a second special alternating current circuit.

12. Rail according to claim 1, characterised in that one of the second or third groups (28, 29) comprises a phase conductor (21, 25) and a neutral conductor (11, 15) of a special alternating current circuit and the other of the second or third groups (28, 29) comprises two conductors (11, 21, 15, 25) for providing the positive and negative pole of a special direct current circuit.

13. Rail according to claim 1, characterised in that one of the second or third groups (28, 29) comprises a phase conductor (21, 25) and a neutral conductor (11, 15) of a special alternating current circuit or two conductors (11, 21, 15, 25) for providing the positive and negative pole of a special direct current circuit and the other of the second or third groups (28, 29) comprises two conductors (11, 21, 15, 25) for providing or forwarding a signal.

14. Rail according to claim 12, characterised in that the conductors (11, 21, 15, 25) are configured to provide the positive and negative pole of the special direct current circuit for providing a direct current at a direct voltage of substantially 24 V.

15. Rail according to one of the preceding claims, claim 1, characterised
in that the inner region (3) is subdivided into an outwardly open first region (4) and an inner second region (5), the second region (5) being accessible through the first region (4), the second region (5) being provided for receiving the adapters (30, 30′, 30″, 70a-d, 70) and the conductor arrangement (7) being arranged within the second region (5), and furthermore in that the outwardly open first region (4) is configured to receive one or more lighting modules (40), in particular flat and elongate lighting modules (40), in the first region (4), in particular to receive them substantially flush with an edge (9) of the rail (1).

16. Rail according to claim 15, characterised
in that side walls (2a) of the rail (1) in the first region (4) are each provided with an engagement geometry (42), in particular a groove-like or rib-like engagement geometry (42), for latching fastening of the lighting modules (40).

17. Lighting arrangement (100) comprising
a rail according to claim 1,
at least one adapter (30, 30′, 30″, 70a-d, 70) inserted into an inner region (3) of the rail, and
at least one device (40, 50, 60, 80) electrically coupled to the adapter (30, 30′, 30″, 70a-d, 70);
wherein the device electrically coupled to the adapter (30, 30′, 30″) is configured as a lighting device (40, 50, 60) and the adapter (30, 30′, 30″) contacts conductors (12-14, 22-24) from the first group (27) of conductors (11-15, 21-25) of the conductor arrangement (7) provided in the inner region (3) of the rail (1) and thereby taps an operating current and a control signal for the lighting device (40, 50, 60) from conductors (12-14, 22-24) of the first group (27); or
wherein the device (80) electrically coupled to the adapter (70a-d, 70) is provided for providing at least one additional function of the lighting arrangement (100) and the adapter (70a-d, 70) contacts at least conductors (11, 21, 15, 25) from the second group (28) or the third group (29) of conductors (11-15, 21-25) of the conductor arrangement (7) provided in the inner region (3) of the rail (1) and thereby taps an operating current and/or taps or feeds in a signal for the additional function.

18. Lighting arrangement according to claim 17, characterised
in that the adapter (30, 30′, 30″) is configured as a first adapter (30, 30′, 30″) and has up to three contact devices (312-314, 322-324) on two opposite sides thereof for contacting conductors (12-14, 22-24) of the first group (27).

19. Lighting arrangement according to claim 17, characterised
in that the adapter (70a-d, 70) is configured as a second adapter (70a-d, 70) and has at least one contact device (711, 721, 715, 725) on two opposite sides thereof for contacting a conductor (11, 21, 15, 25) of the second or third group (28, 29) or at least two contact devices (711, 721, 715, 725) on two opposite sides thereof for selectively contacting an associated conductor (11, 21, 15, 25) of the second or third group (28, 29).

20. Lighting arrangement according to claim 19, characterised
in that the second adapter (70a-d, 70) additionally has at least one contact device (713, 723) on the two opposite sides thereof for contacting an associated conductor (13, 23) of the first group (27).

21. Lighting arrangement according to claim 17, characterised
in that the device (80) electrically coupled to the adapter (70a-d, 70) for providing the additional function is configured as an emergency light module (80) or as an illuminable emergency information device or as an illuminable indication device or as a loudspeaker module or as a sensor module.

22. Lighting arrangement according to characterised
in that the adapter (30, 30′, 30″, 70a-d, 70) has a converter for converting the tapped operating current.
